(19) United States
(12) Patent Application Publication
(10) Pub. No.: US 2007/0140536 A1
(43) Pub. Date: Jun. 21, 2007

(54) Medical image processing method and apparatus

(75) Inventors: William J. Sehnert, Fairport, NY (US); Lynn M. Fletcher-Heath, Rochester, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 11/305,977

(22) Filed: Dec. 19, 2005

(51) Int. Cl. G06K 9/00

(52) U.S. Cl. 382/128

(57) ABSTRACT

A method for processing digital x-ray images to maximize diagnostic information. The method includes accessing a raw digital image signal generated by imaging a patient with an imaging modality and transmitting the raw image to an acquisition workstation. The acquisition workstation classifies the image and assigns a plurality of image processing conditions. The raw digital signal is processed according to each processing condition. The plurality of processed images are transmitted to a display workstations for review.

### FIELD OF THE INVENTION

The invention relates to an image processing apparatus for processing an image signal, representing a diagnostic image, under a plurality of processing conditions so as to produce a complementary set of visible images optimal for diagnosis.

### BACKGROUND OF THE INVENTION

Digital radiography refers to a general system, or modality, for recording a digital radiation image from the transmission of X-rays through the body of an object, e.g., a patient. There are several technologies for digitally recording X-ray image signals. In the medical imaging community, the two technologies are generally known as direct radiography (DR) and computed radiography (CR).

In a DR system, a flat-panel detector is used to measure and record X-ray exposure. The flat-panel detector responds to the incident X-rays by generating a charge that is in proportion to the incident radiation exposure. The resulting charge is read out by an active matrix array to produce a digital signal.

A CR system utilizes stimulable phosphor materials, usually formed as a plate. The phosphor plate forms a latent image in response to incident X-ray exposure. The latent image is converted into visible light by scanning with a laser beam. The visible light is guided to a photodetector where it is converted into an electronic signal and subsequently digitized to produce a digital signal.

For either DR or CR technology, the output digital signal is usually converted into a unit that is linear with the logarithm of incident exposure. Such systems can record radiation exposure over a wide dynamic range, typically on the order of 10,000:1, so that exposure error is seldom a problem.

Due to the wide dynamic range of digital radiography, the raw digital signal produced by the modality must be enhanced to produce a visible image suitable for diagnosis by a medical clinician. Image enhancement techniques typically manipulate the spatial frequency components of the image, in order to sharpen edges and to increase the local contrast, and create a tonescale curve, in order to render a visible image with sufficient global contrast. Algorithms designed to implement an enhancement strategy are usually parameterized by a set of image processing conditions that describe the details of the strategy. For example, such conditions will specify which spatial frequencies are to be modified, to what degree, and the like. Various image processing algorithms have been disclosed, for example, U.S. Pat. Nos. 5,978,518 (Oliyide) and 6,069,979 (VanMetter), and 5,644,662 (Vuylsteke).

When a proposed image enhancement method is applied to an actual image, it must be determined what particular processing condition should be used. For digital radiographic imaging modalities, which handle a large number of images, it is inefficient to have users manually adjust the parameters for each individual image. Consequently, images are commonly grouped and the image processing condition is determined in advance for each group. For example, in digital radiography systems, the images are often grouped by the body part examined (e.g. chest, abdomen, shoulder, or foot) and/or the projection (e.g. posteroanterior, lateral, or oblique).

The disadvantage to the above grouping method is that a single processing condition will not be optimal for each of the variety of disease states associated with a given body part. Consider, for example, radiographic images of the posteroanterior (PA) chest. In this type of image, it is sometimes desired to detect or rule out the presence of pulmonary nodules. For this detection task, it has been noted that performance can be improved by specifying a processing condition that boosts a wide spectrum of spatial frequencies from very low to very high (see Muller R D, Von Koschitzki T, Hirche H, John V, Hering K, Gocke C, Turowski B, “Frequency-filtered image post-processing in digital luminescence radiographs in pulmonary nodule imaging,” Clin Radiol. 1996 August ; 51 (8):577-86). However, that processing condition may not be appropriate for the task of resolving the fine linear structures of interstitial lung disease (see Schaefer C M, Greene R, Llewellyn H J, Mrose H E, Pile-Spellman E A, Rubens J R, Lindeman S R, “Interstitial Lung Disease: Impact of Postprocessing in Digital Storage Phosphor Imaging,” Radiology 1991 March; 178-(3):733-38). In the latter case, it has been suggested to boost only mid-level to very high frequencies to improve the task performance.

U.S. Pat. No. 5,172,418 (Ito) discloses a processing apparatus wherein the image grouping is further refined by adding a disease category. Processing conditions can be chosen to emphasize prospective pathological features. Additionally, the apparatus allows for the possibility that an image be assigned a plurality of potential disease classifications, thus producing a plurality of processing conditions for an image. However, processing conditions targeted towards a predetermined selection of likely diseases may decrease detectability of other serious diseases that may not be suspected, i.e. the success rate for making an incidental finding may be reduced.

A paper titled “Automated Hands-Free Image Manipulation and Viewing: A useful Macro Feature that Assists Radiologists in the Viewing of Chest and Extremity Digital Radiographs,” published in Journal of Digital Imaging, volume 15, supplement 1, 2002, by Koenker and Grover describes an apparatus that will display a digital radiographic image on a softcopy workstation. The workstation can be configured in a way to let the user view the image, in addition to a normal default presentation, under a plurality of processing conditions, including reverse grayscale and high spatial frequency edge enhancement. The additional presentations of the image is intended to improve the accuracy of the doctor's interpretation. However, the digital images received by the softcopy workstation will have already been processed for frequency emphasis and tonescale rendering at the originating modality, thus limiting the additional amount of visual information that can be extracted by supplementary processing. Furthermore, the additional presentations of the image are defined only at the local workstation and are not recorded with the image for future reference or viewing on another softcopy workstation.

Thus, there exists a need for an apparatus and method for processing an image signal, representing a diagnostic image, under a plurality of processing conditions so as to produce a complementary set of visible images optimal for diagnosis.

### SUMMARY OF THE INVENTION

An object of the present invention is to provide a method and apparatus for processing raw digital X-ray image signals for presentation to a clinician in a way that enables maximal visual diagnostic information to be conveyed.

According to the present invention, the image processing apparatus comprises an X-ray imaging modality, an acquisition workstation, a network server, an optional image archive, and at least one display workstation.

The modality provides raw image signals (i.e., no image processing has been applied) to the acquisition workstation, where images are classified and stored. An acquisition workstation includes an image processing condition storage unit that records a plurality of conditions for each classification type. Of the plurality of conditions for an image type, exactly one is identified as a default processing condition, while the additional, alternative, conditions may be identified by other means, such as descriptive text. In a preferred embodiment of the present invention, the default processing condition is chosen in a manner to provide a visible image that, subject to a single presentation, maximizes the diagnostic information content within the image signal. Further, in the preferred embodiment, the alternative processing conditions are chosen to provide complementary views of the image signal that, overall, convey more information than any one single presentation can offer. Examples of alternative processing conditions are: grayscale reversal, increased (decreased) edge enhancement, increased (decreased) local contrast, increased (decreased) global contrast or any combination of such conditions.

Generally, the acquisition workstation sends the raw image signal and its plurality of image processing conditions to a network server. The network server applies the default image processing condition to the raw image signal to generate a default processed image. Further, the network server provides additional renderings of the raw image signal according to the alternative image processing conditions. The additional renderings can be provided to an archive as reduced resolution thumbnail images, in order to significantly reduce the load of network traffic and the processing of the network server. Each thumbnail image includes identifying information referring to the original raw image signal as well as the complete specification of the image processing condition used to generate the thumbnail image. From the archive, the default processed image and the additional renderings are forwarded to one or more display devices for clinical review.

At the display device, a user can view the processed images and has the option to request that any or all of the processed images be made available at full resolution. On the display device, basic image processing operations can be applied.

According to one aspect of the present invention, there is provided a method of processing medical image data. The method includes the steps of: providing a database comprised of a plurality of image classifications, each image classification having an associated at least two image processing conditions; classifying the medical image data; employing the database to identify the at least two image processing conditions associated with the medical image data's classification; processing the diagnostic image data using one of the image processing condition to generate a first processed image; processing the diagnostic image data using the other image processing condition to generate a second processed image; and transmitting the first and second processed images to a display device to allow display of the first and second processed images, either individually or simultaneously. In one embodiment, one of the two processing conditions is the default condition, and the other is a non-default processing condition.

The present invention provides some advantages. For example, the apparatus processes a raw digital X-ray image signal with a plurality of image processing conditions to increase the amount of diagnostic information conveyed to a clinician relative to a presentation provided by a solitary processing condition. The method allows users to customize the plurality of conditions based on classification type and institution and user preferences. The method also provides an implementation that has minimal impact on network traffic and processor burden. A user is able to readily select for review one or more of the alternatively rendered images. Further, with regard to marking, one or more of the additional images can be marked as a “key image” for diagnostic purposes.

### BRIEF DESCRIPTION OF THE DRAWINGS

The foregoing and other objects, features, and advantages of the invention will be apparent from the following more particular description of the embodiments of the invention, as illustrated in the accompanying drawings. The elements of the drawings are not necessarily to scale relative to each other.

FIG. 1 generally shows a block diagram of an image processing apparatus suitable for the method of the present invention.

FIG. 2 illustrates an exemplary workflow of the acquisition workstation of FIG. 1

FIG. 3 illustrates an exemplary workflow using the image processing unit of the network server of FIG. 1.

FIG. 4 shows a general flowchart of the method of the present invention.

FIG. 5 shows an exemplary display of a display device showing one of the processed images.

FIG. 6 shows an exemplary display of a display device simultaneously showing a default processed image and a non-default processed image.

### DETAILED DESCRIPTION OF THE PREFERRED EMBODIMENTS

The following is a detailed description of the preferred embodiments of the invention, reference being made to the drawings in which the same reference numerals identify the same elements of structure in each of the several figures.

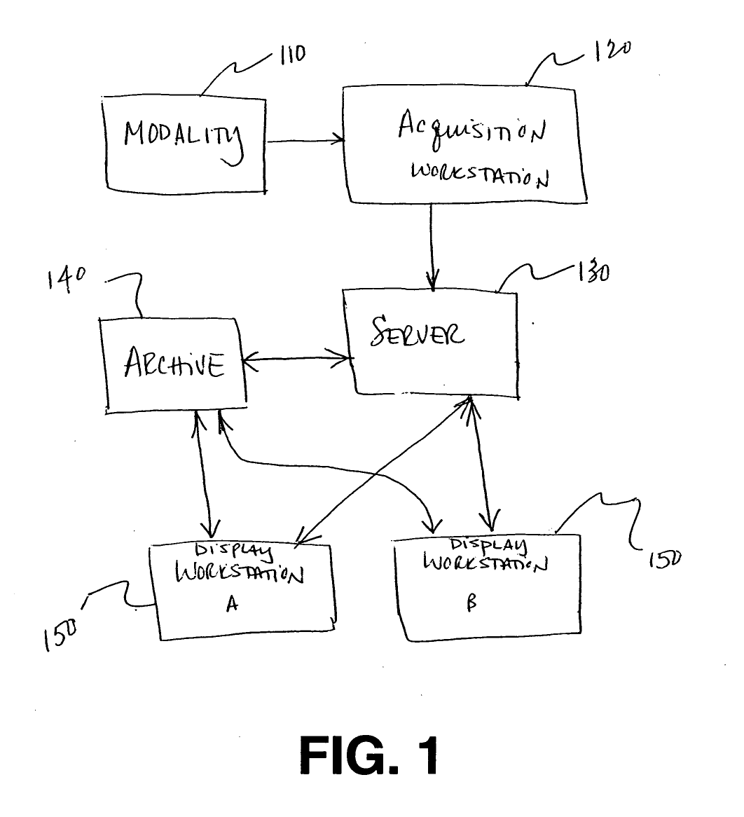

FIG. 1 generally illustrates a block diagram of an image processing apparatus suitable for the method of the present invention. The apparatus 100 comprises an X-ray imaging modality 110, an acquisition workstation 120, a network server 130, an optional image archive 140, and at least one display workstation/device 150. The elements are in communication, for example, using a high-bandwidth network or a dedicated interface port.

X-ray imaging modality 110 is typically either a CR or a DR imaging device. The imaging modality 110 is preferably in direct communication with acquisition workstation 120. During operation, modality 110 generates raw digital X-ray signals and transmits them to acquisition workstation 120.

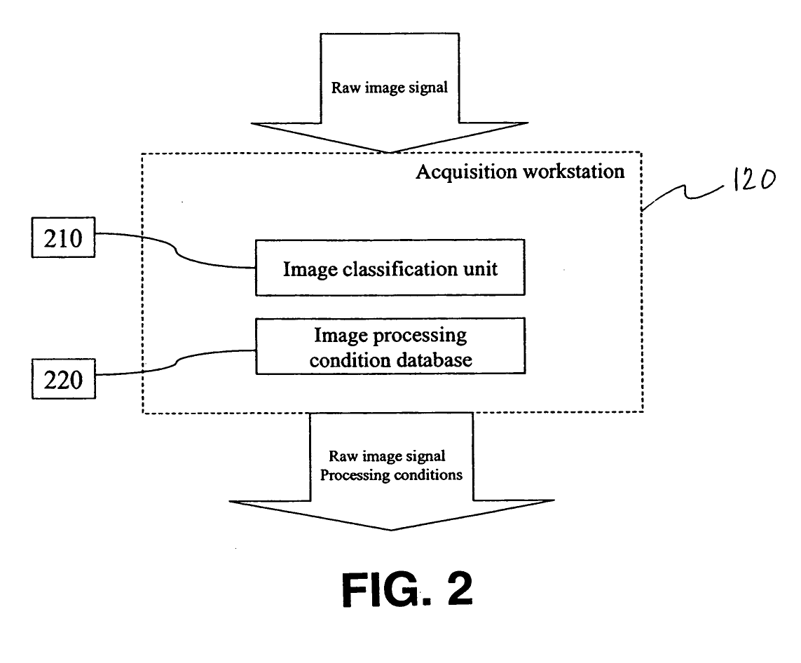

Referring now to FIG. 2, acquisition workstation 120 includes an image classification unit 210 and an image processing condition database 220. Database 220 maintains a configurable list of categories for image classification. For each element in the category list, database 220 also stores a plurality of user-configurable image processing conditions. Any number of image processing conditions can be stored per list element, however one is identified as the default condition. The other, non-default, processing conditions may be identified, for example, by a textual descriptor revealing its intended purpose, e.g. “Reverse grayscale”. As such, the plurality of image processing conditions are comprised of a single default image processing condition and at least one non-default image processing condition.

In a preferred embodiment, the default image processing condition is chosen to produce an image that, subject to a single presentation, maximizes the diagnostic information content from within the raw image signal. Also in a preferred embodiment, the additional, non-default, image processing conditions are chosen to provide complementary views of the image signal that, overall, convey more diagnostic information than any one single presentation can offer. Relative to the default image processing condition, examples of alternative processing conditions are: grayscale reversal, increased (decreased) edge enhancement, increased (decreased) local contrast, increased (decreased) global contrast or any combination of such operations.

As the raw image signal is transmitted from modality 110 to acquisition workstation 120, it is uniquely classified by image classification unit 210 as one of the elements from the category list in database 220. Image classification unit 210 can be as simple as a user interface requiring a user to select the type from a list, or it could be a more sophisticated process wherein the assigned type is based on a totally automated classification algorithm. Based on the classification, a plurality of image processing conditions are retrieved from database 220 and assigned to the raw image signal. Acquisition workstation 120 then transmits the raw image signal, along with its plurality of processing conditions (i.e., the default processing condition and the at least one non-default image processing condition), to network server 130 for subsequent processing and further disbursement.

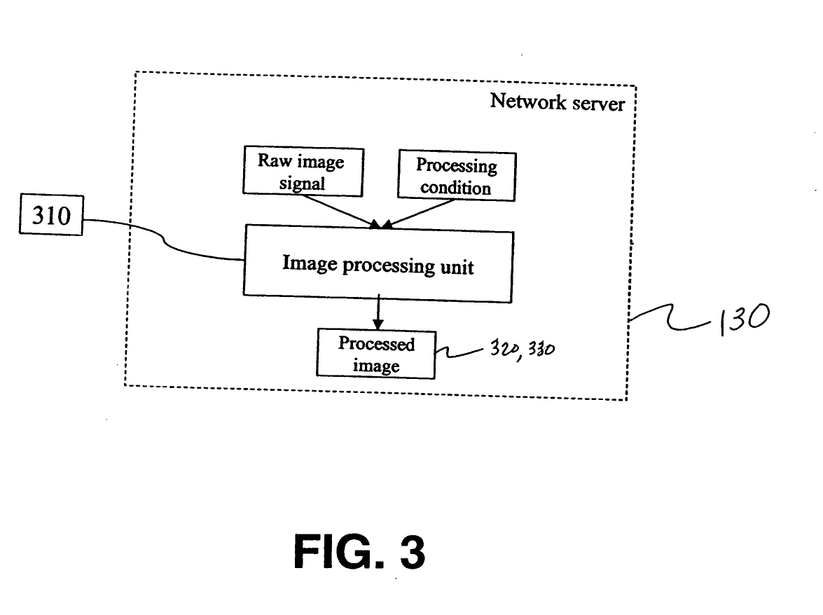

Shown in FIG. 3, network server 130 includes an image processing unit 310 that carries out image processing. Image processing unit 310 accepts the input a raw image signal from acquisition workstation 120 and processes the signals according to the plurality of processing conditions to generate a plurality of processed images—a default processed image 320 and at least one alternative processed image 330.

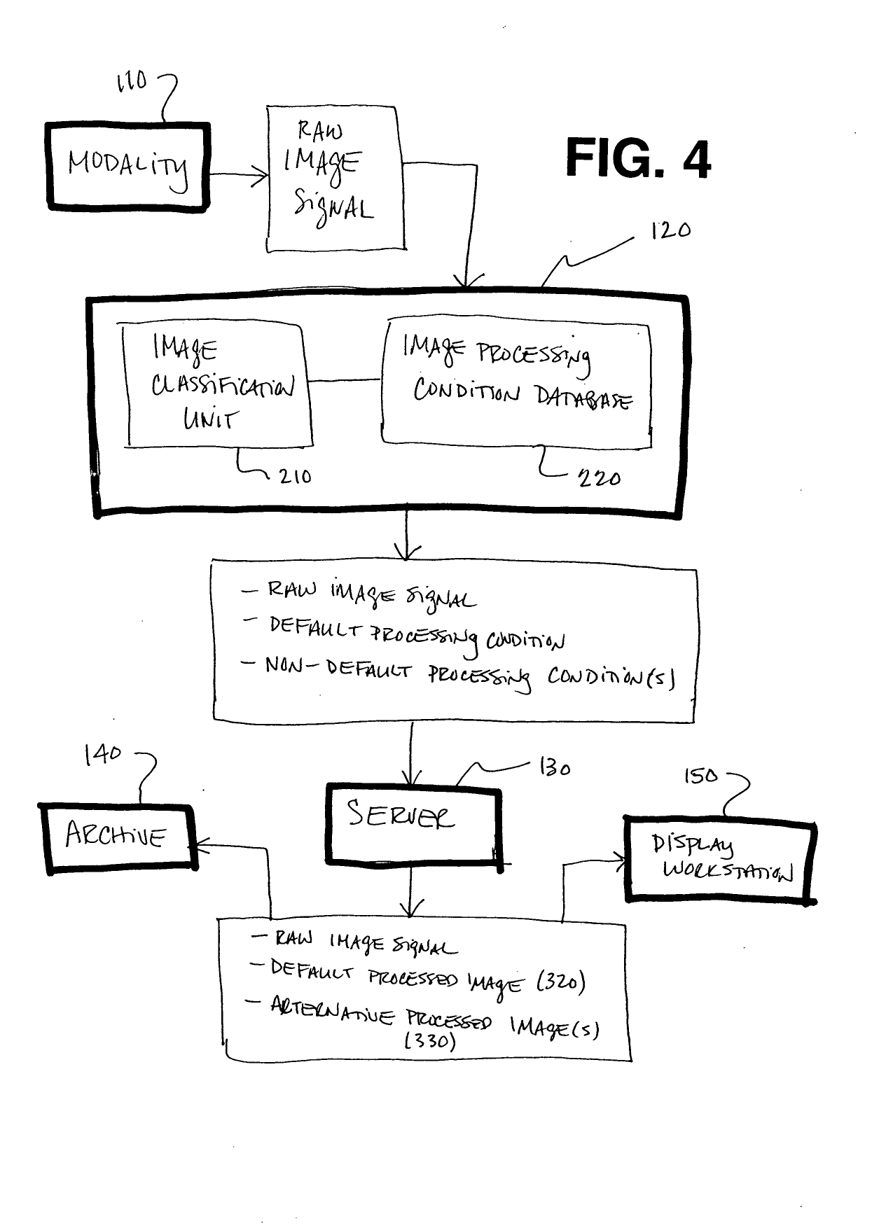

Referring now to both FIG. 3 and 4, network server 130 receives the raw image signal along with the plurality of processing conditions. The raw image signal and the default processing condition are fed to image processing unit 310 to create default processed image 320. Network server 130 then sends the resulting default processed image to the image archive 140, if present, or directly to one or more display workstations 150 for reading by a clinician. Default processed image 320 includes a reference to the original raw image data from which it was derived, and also includes information sufficient to identify the specific image processing conditions applied in its creation.

The raw image signal and the remaining plurality of processing condition (i.e., the at least one non-default image processing condition) are fed to image processing unit 310 to create at least one alternative processed image 330. Network server 130 can provide renderings of the raw image to archive 140 or display workstations 150 according to the non-default image processing conditions. In a preferred embodiment, alternative processed image 330 shall initially be provided to the archive, if present, or alternatively to the display workstation as reduced resolution thumbnail images, in order to significantly reduce the load of network traffic and the processing burden of the network server. Each thumbnail image contains identifying information referring to the original raw image as well as the specifications of the image processing condition represented by the thumbnail image.

Image archive 140, when present, can also receive a copy of the raw image and the plurality of processing conditions, as well as the default-processed image. It receives these from network server 130. Image archive 140 has the ability to provide images to display workstations 150 at the specific request of the workstation user. Image archive 140 can employ pre-fetching rules that locate previously acquired studies that are related to the new images, making these prior studies available for quick access. Image archive 140 can also include distribution rules for forwarding the new full resolution images, the newly created thumbnail images, and/or the relevant prior studies to appropriate display workstations 150 for reading by a clinician. These rules can incorporate additional information including, but not limited to designated users, type of image, and the diagnostic or clinical tasks performed on specific display workstations 150.

When optional image archive 140 is not present in an embodied system, network server 130 can send all the images directly to one or more display workstations 150.

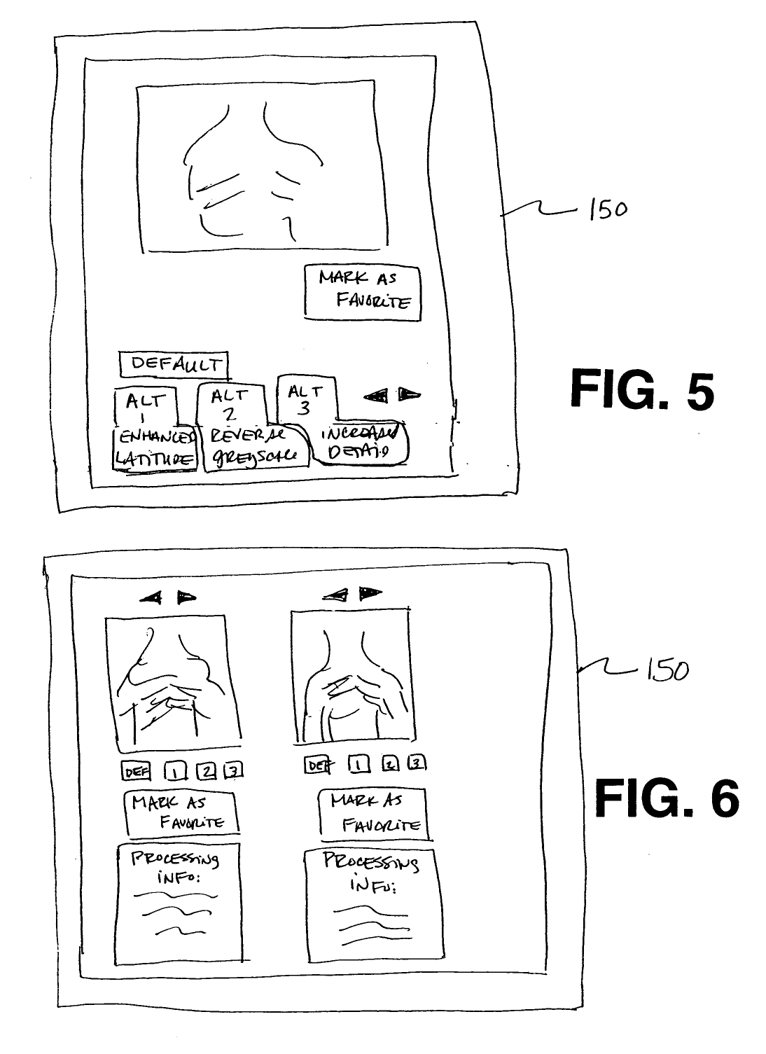

Referring now to FIGS. 5 and 6, display workstation 150 can indicate that default processed image 320 as well as the alterative processed image(s) 330 are available. Initially the user can view default processed image 320 as well as the reduced resolution renderings of alterative processed image 330. Through the display workstation's user interface, the user can then request to view one or more of the alternative processed images 330 at full resolution. This selection sends a request to network server 130, which then re-processes the raw image, by means of image processing unit 310, to create full resolution versions of the image with each of the selected alternative processing conditions applied. Each newly created image includes a reference to the original raw image data from which it was derived, and also includes information sufficient to identify the specific image processing conditions applied in its creation. Network server 130 then transmits each of these images to display workstation 150 from which the request was initiated for review. If image archive 140 is present, these alternatively processed images are also transmitted to archive 140, which can be responsible for distribution to display workstation 150. The same distribution rules used to send the original image are employed to forward the new image(s) to the display workstations.

Descriptive text can be displayed to assist the user in distinguishing the processed images available for viewing. The text can be descriptive of the processing conditions by which the medical image data was processed. For example, as shown in FIG. 5, Alternate Image 1 has enhanced latitude, Alternate Image 2 has reverse grayscale, and Alternate Image 3 has increased detail.

Image archive 140, if present, may cache any or all alternative processed images 330 in its storage. If cached, the system may retrieve the requested image or images from those cached images in image archive 140 rather than recomputing them in network server 130.

At display workstation 150, a user can apply basic image processing operations to the displayed images, including changing display magnification, adjusting displayed brightness and contrast, modifying image orientation, and the like. In particular, the user can designate that any one or more of the default and/or alternative processed images is a “key image” or “favorite image”, specifically indicating that this particular image (or images) is of special interest for diagnosis. The “key image” designation can be associated with the particular image at display workstation 150 and stored in archive 140, if present. The “key image” designation can then serve as a cue or notation to all subsequent reviewers that such image(s) was significant for diagnosis.

As best shown in FIG. 6, specific information regarding the particular processing condition can be displayed.

It is noted that in some situations it may be desirable to store the image processing conditions along with the processed image. For example, for long term archival storage, and/or where it may be difficult to retain the image processing software used to render the image.

A computer program product may include one or more storage medium, for example; magnetic storage media such as magnetic disk (such as a floppy disk) or magnetic tape; optical storage media such as optical disk, optical tape, or machine readable bar code; solid-state electronic storage devices such as random access memory (RAM), or read-only memory (ROM); or any other physical device or media employed to store a computer program having instructions for controlling one or more computers to practice the method according to the present invention.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

1. A method of processing medical image data, comprising the steps of:
providing a database comprised of at least one image classification having an associated at least two image processing conditions;
classifying the medical image data;
employing the database to identify the at least two image processing conditions associated with the medical image data's classification;
processing the diagnostic image data using one of the image processing condition to generate a first processed image;
processing the diagnostic image data using the other image processing condition to generate a second processed image; and
transmitting the first and second processed images to a display device to allow display of the first and second processed images, either individually or simultaneously.

2. The method of claim 1, wherein the first and second processed images are full resolution images.

3. The method of claim 1, wherein the first processed image is a low resolution image and the second processed image is a full resolution image.

4. The method of claim 1, further comprising the steps of:
transmitting the medical image data to the display device; and
allowing the medical image data to be displayed on the display device.

5. The method of claim 1, further comprising the step of providing means for a user to select either the first or second processed image as a preferred image.

6. The method of claim 5, further comprising the step of providing a notation, on the display device, indicating the preferred image.

7. The method of claim 5, further comprising the step of storing the preferred image.

8. The method of claim 1, further comprising the steps of:
providing means for a user to indicate either the first or second processed image as a preferred image;
storing the preferred image with the medical image data; and
retrieving the stored preferred image when the medical image data is accessed.

9. The method of claim 1, further comprising the step of storing the medical image data with the associated at least two image processing conditions.

10. A method of processing medical image data, comprising the steps of:
providing a database comprised of a plurality of image classifications, each image classification having an associated at least two image processing conditions;
classifying the medical image data;
employing the database to identify the at least two image processing conditions associated with the medical image data's classification;
processing the diagnostic image data using one of the image processing condition to generate a first processed image;
processing the diagnostic image data using the other image processing condition to generate a second processed image;
transmitting the first and second processed images to a display device to allow display of the first and second processed images, either individually or simultaneously;
providing means for a user to indicate either the first or second processed image as a preferred image;
providing a notation, on the display device, indicating the preferred image; and
storing the preferred image.

11. A method of processing medical image data, comprising the steps of:
providing a database comprised of a plurality of image classifications, each image classification having an associated at least two image processing conditions, one of the associated image processing conditions being a default image processing condition and the other being a non-default image processing condition;
classifying the medical image data;
employing the database to identify the at least two image processing conditions associated with the medical image data's classification;
processing the diagnostic image data using the default image processing condition to generate a non-default processed image;
processing the diagnostic image data using the non-default image processing condition to generate a default processed image; and
transmitting the default processed image and the non-default processed image to a display device to allow display of the default and non-default processed images, either individually or simultaneously.

12. The method of claim 11, wherein the default and non-default processed images are full resolution images.

13. The method of claim 11, wherein the default processed image is a full resolution image and the non-default processed image is a low resolution image.

14. The method of claim 11, further comprising the steps of:
transmitting the medical image data to the display device; and
allowing the medical image data to be displayed on the display device.

15. The method of claim 11, further comprising the step of providing means for a user to select either the default or non-default processed image as a preferred image.

16. The method of claim 15, further comprising the step of providing a notation, on the display device, indicating the preferred image.

17. The method of claim 15, further comprising the step of storing the preferred image.

18. The method of claim 11, further comprising the steps of:
providing means for a user to indicate either the default or non-default processed image as a preferred image;
storing the preferred image with the medical image data; and
retrieving the stored preferred image when the medical image data is accessed.

19. The method of claim 1 1, further comprising the step of storing the medical image data with the associated at least two image processing conditions.

20. The method of claim 11, further comprising the step of adding descriptive text descriptive of the processing conditions by which the medical image data was processed.
